(19) United States
(12) Patent Application Publication
(10) Pub. No.: US 2004/0042761 A1
(43) Pub. Date: Mar. 4, 2004

(54) Recording/reproducing apparatus

(76) Inventor: Hiroyuki Miyazaki, Takefu-City (JP)

Correspondence Address: WENDEROTH, LIND & PONACK, L.L.P., 2033 K STREET N. W., SUITE 800, WASHINGTON, DC, 20006-1021, US

(21) Appl. No.: 10/452,048

(22) Filed: Jun. 3, 2003

(30) Foreign Application Priority Data
Jun. 3, 2002 (JP) 2002-161413

(51) Int. Cl. H04N 5/76; H04N 5/91; H04N 7/00; H04N 5/781; H04N 5/85; H04N 5/90

(52) U.S. Cl. 386/46; 386/125; 348/231.1

(57) ABSTRACT

A recording/reproducing apparatus is provided, which can easily confirm a remaining capacity of a hard disc without taking any specific steps. When a power supply is turned on, a main microcomputer transmits a remaining capacity confirmation command to a HDD microcomputer. The HDD microcomputer implements an initial search, checks a remaining capacity, and sends back a search result to the main microcomputer. The main microcomputer determines a remaining capacity of the hard disc judging from the received search result, and turns on LEDs of a display depending on a remaining capacity of the hard disc.

### BACKGROUND OF THE INVENTION

1. Field of the Invention

The present invention relates to a recording/reproducing apparatus having a recording medium on which various types of information such as videos and audios are recorded as digital data, and especially relates to a recording/reproducing apparatus incorporated in a home digital electrical appliance such as a digital TV, a digital video disc recorder/player or the like.

2. Prior Art

For example, a recent recording/reproducing apparatus for recording and reproducing TV broadcasting programs or video pictures uses disc-shaped recording medium such as hard disc, DVD and so forth as a random-access mass-storage means.

When a program or a motion picture is recorded on a recording medium, digital data encoding video signals are stored and one video file is formed. Here, some video signals include audio signals and some other video signals do not include audio signals. A capacity of a recording medium is searched at the time of recording, and a current consumed capacity or a remaining capacity can be confirmed.

The above-described recording/reproducing apparatus is connected to a monitor, for example, a TV monitor for displaying reproduced video pictures. For confirming a remaining capacity, a power supply of a monitor is turned on, and a remote controller is operated so that a menu panel is displayed on the monitor and the panel is changed to a remaining capacity confirmation panel. Thus, a current consumed capacity is displayed on the monitor, thereby enabling a user to confirm a remaining capacity.

By confirming a remaining capacity, a user can confirm whether there exists a remaining capacity for recording a program, so that a user can avoid such a mistake that recording is terminated in the middle of the program. Furthermore, depending on a remaining capacity, a recording mode can be selected from: XP(High quality); SP(Standard); and LP(Long), and besides a capacity for recording can be adjusted by making an arrangement such as deletion or edition of a file.

For displaying a remaining capacity on a monitor, it is necessary to turn on a power supply of a monitor and to operate a remote controller to display the capacity on the monitor. Accordingly, it takes time and trouble to confirm a remaining capacity. When an urgent recording of a program is required, recording is performed without confirming a remaining capacity for recording. As a result, it is likely that a program is not recorded to its end.

In Japanese Patent Application laid open under No. 2001-307465, it is described that, when it is found that a monitored remaining capacity of a recording medium is less than a threshold, a notice to that effect is displayed on a screen. In Japanese Patent Application laid open under No. 5-28726, it is described that a remaining capacity on every recording performance is detected and displayed on a screen.

In these two prior arts, an operation using a remote controller is not required. However, in the former case, a remaining capacity is displayed only when it becomes low, so that a user cannot confirm a remaining capacity constantly. Likewise, in the latter case, a remaining capacity is not always displayed on a screen. For example, a remaining capacity is not displayed when a power supply of a recording/reproducing apparatus is turned on, so that it is inconvenient to a user.

### SUMMARY OF THE INVENTION

It is therefore an object of the present invention to provide a recording/reproducing apparatus which can constantly confirm a remaining capacity of a recording medium without taking troubles.

In order to attain the above object, the present invention provides a recording/reproducing apparatus comprising a random access recording medium, a remaining capacity monitor means for monitoring a remaining capacity of the recording medium, a display for displaying a remaining capacity, and a control means for displaying a remaining capacity obtained from the remaining capacity monitor means on the display when a power supply is turned on.

The control means controls the display so as to display a remaining capacity constantly and to renew the remaining capacity by obtaining a new remaining capacity from the remaining capacity monitor means at regular time intervals.

The remaining capacity monitor means monitors a remaining capacity of the recording medium constantly while operating. Accordingly, when a power supply is turned on, information of a remaining capacity is obtained from the remaining capacity monitor means, so that a remaining capacity is automatically displayed without any specific operation.

In case information of a remaining capacity is obtained periodically from the remaining capacity monitor means after a power supply is turned on, the information of a remaining capacity can be renewed without any specific operation, thereby making it possible to display a remaining capacity accurately.

### BRIEF DESCRIPTION OF THE DRAWINGS

FIG. 1 is a schematic block diagram showing one embodiment of a recording/reproducing apparatus according to the present invention;

FIG. 2 is a view showing a front panel of the recording/reproducing apparatus;

FIG. 3 is a flowchart with respect to an indication of a remaining capacity at the time of power-on; and

FIG. 4 is a flowchart with respect to an indication of a remaining capacity after power-on.

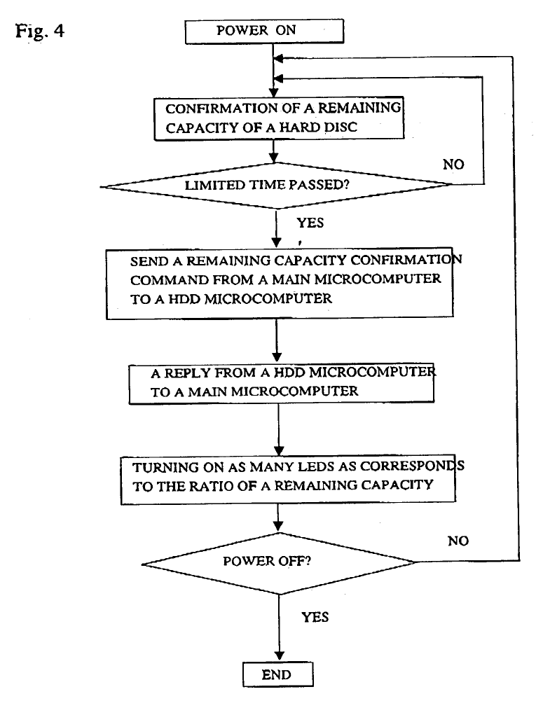

### DETAILED DESCRIPTION OF THE PREFERRED EMBODIMENTS

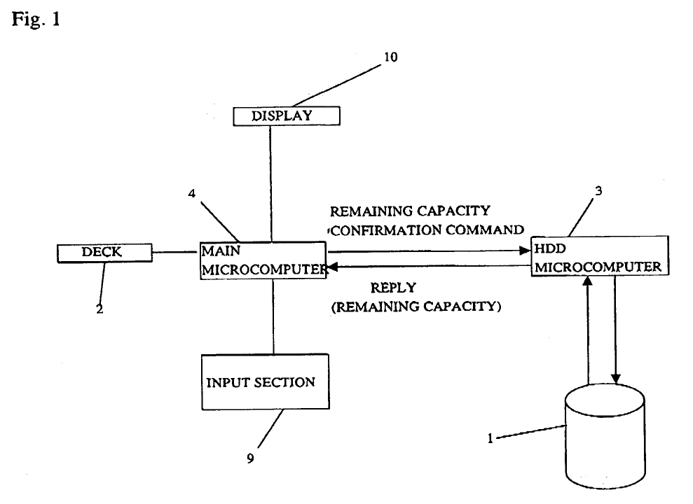

One embodiment of a recording/reproducing apparatus according to the present invention is shown in FIG. 1. The recording/reproducing apparatus is provided with a hard disc 1 as a recording medium and a video cassette tape deck 2. The hard disc 1 is driven and controlled by a HDD microcomputer (hard disc microcomputer) 3 to record and reproduce digital data. The deck 2 is driven and controlled by a main microcomputer 4 to record and reproduce analog data. The main microcomputer 4 also controls the recording/reproducing apparatus in its entirety.

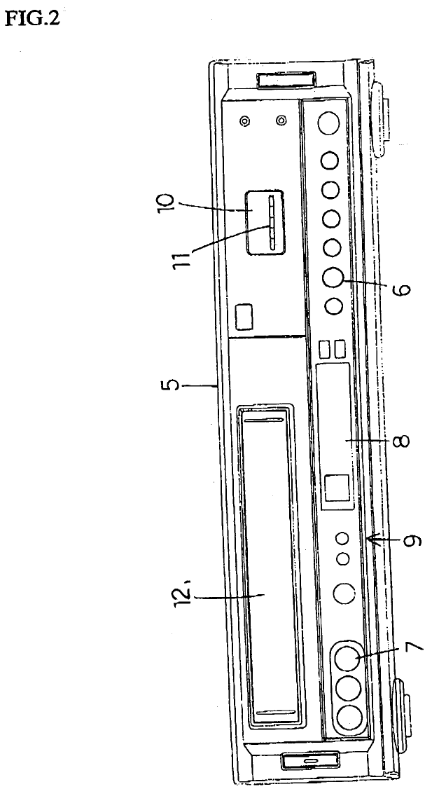

As shown in FIG. 2, a front panel 5 of the recording/reproducing apparatus is provided with an input section 9 having a plurality of keys 6, an input terminal 7 and a display window 8, and further provided with a display 10 for displaying a remaining capacity of the hard disc 1. The display 10 is provided with a plurality of LEDs 11 aligned in a row, 5 LEDs in this case. A numeral 12 in the drawing represents a loading slot for a video cassette tape.

Video signals from a tuner or video signals inputted from externals are converted to digital signals, and the thus obtained digital data are written in the hard disc 1 with a given capacity of file formed therein. The HDD microcomputer 3 constantly searches, while a power supply is turned on, a consumed capacity out of the full capacity of the hard disc 1 regardless whether the hard disc 1 is recording or reproducing, thereby recognizing a remaining capacity of the hard disc 1. Namely, the HDD microcomputer 3 has a monitor function for monitoring a remaining capacity of the hard disc 1.

The main microcomputer 4 obtains information of a remaining capacity of the bard disc 1 from the HDD microcomputer 3 at the time of power-on and after power-on, and drives the display 10 for displaying a remaining capacity of the moment.

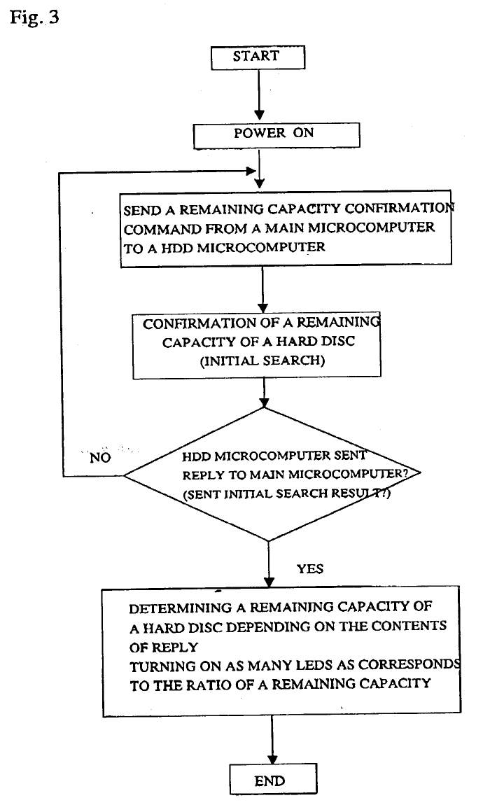

Namely, as shown in FIG. 3, when a power supply is turned on, the main microcomputer 4 transmits a remaining capacity confirmation command to the HDD microcomputer 3. The HDD microcomputer 3 has access to the hard disc 1 and starts an initial search for confirming a remaining capacity of the moment. When the HDD microcomputer 3 confirms a remaining capacity by checking a consumed capacity of the hard disc 1, the HDD microcomputer 3 sends a reply with an initial search result to the main microcomputer 4.

When there is no reply from the HDD microcomputer 3 within a predetermined time, it means that there occurred some errors such as troubles in a recorded file or the like and an initial search jammed. When no reply is reached after a predetermined time, the main microcomputer 4 transmits a remaining capacity confirmation command to the HDD microcomputer 3 once again. The HDD microcomputer 3 checks, while repairing a file in trouble, a consumed capacity, and sends back a search result to the main microcomputer 4. The main microcomputer 4, after receiving an initial search result, determines the consumed capacity, i.e., a remaining capacity, of the hard disc 1. By calculating a ratio of a remaining capacity to the full capacity, the main microcomputer 4 drives the display 10 to turn on the LEDs 11 depending on the obtained ratio.

The display 10 indicates 5-level capacity using five LEDs. Namely, when ⅕ (20%) out of the full capacity of the hard disc 1 is consumed, one LED is turned on. When four LEDs are turned on, a user can be noticed that a consumed capacity is ⅘ (80%) out of the full capacity of the hard disc 1 and a remaining capacity of the hard disc 1 is ⅕ (20%). When there exists no remaining capacity, all LEDs are turned on or the emitting color of the LED 11 may be changed to another one in order to draw a user's attention.

Thus, when a power supply is turned on, a remaining capacity can be displayed as a ratio to the full capacity of the hard disc 1 and a user can confirm the remaining capacity at a glance. The full capacity of the hard disc 1 is limited, and recording time varies depending on a recording mode. Thus, the remaining recording time varies. However, by displaying a remaining capacity using a ratio, a user can obtain a rough standard regardless of a recording time.

While the recording/reproducing apparatus is used after a power supply is turned on, digital data is written into or deleted from the hard disc 1, so that a consumed capacity varies. The HDD microcomputer 3 monitors constantly the operation of the hard disc 1 to check a consumed capacity and confirms a remaining capacity of the moment. The main microcomputer 4 transmits, while a power supply is turned on, a remaining capacity confirmation command to the HDD microcomputer 3 at regular time intervals.

When received such a command, the HDD microcomputer 3 sends back a consumed capacity of the hard disc 1 of the moment to the main microcomputer 4. The main microcomputer 4 can obtain a latest remaining capacity, and the LEDs 11 of the display 10 are turned on in compliance with a remaining ratio in the manner as described above. Such an operation is repeated until a power supply is turned off.

A user can confirm a remaining capacity of the hard disc 1 at any time by renewing the information of remaining capacity periodically while a power supply is turned on. Accordingly, when a recording reservation is made, there is no need to take any specific steps for confirming a remaining capacity, and the usability of the apparatus is improved.

While there has been described in connection with the preferred embodiments of the invention, it will be obvious to those skilled in the art that various changes and modifications may be made within the scope of the invention. For example, instead of hard disc, rewritable DVD, CD, and a semiconductor memory are applicable as a recording medium. A recording/reproducing apparatus employing such a recording medium may be a home digital electrical appliance such as a TV, a video tape recording/reproducing player, an audio appliance, an electric oven, a refrigerator, a printer or the like, which processes digital data.

A display may be constituted of a bar gauge, indicating a ratio of a remaining capacity to the full capacity. A remaining capacity can be displayed in more detail by increasing the number of LED. An emitting color of LED may be changed depending on a remaining capacity.

As explained heretofore, according to the present invention, as far as a power supply is turned on, a remaining capacity of a recording medium such as a hard disc can be displayed automatically. Therefore, there is no need to turn on a power supply of a TV monitor or to take any specific steps for confirming a remaining capacity. Thus, even when it is urgently necessary to record a program or the like, a remaining capacity can be confirmed at once. Accordingly, it is possible to decide whether to record on the recording medium in compliance with the remaining capacity or to record on another recording medium. Thus, a user can avoid making such a mistake that recording is terminated in the middle of the program.

What is claimed is:

1. A recording/reproducing apparatus comprising a random access recording medium, a remaining capacity monitor means for monitoring a remaining capacity of the recording medium, a display for displaying a remaining capacity, and a control means for displaying a remaining capacity obtained from said remaining capacity monitor means on said display when a power supply is turned on.

2. A recording/reproducing apparatus as claimed in claim 1, wherein said control means controls said display so as to display a remaining capacity constantly after a power supply is turned on and to renew said remaining capacity by obtaining a new remaining capacity from said remaining capacity monitor means at regular time intervals.
